(19) United States
(12) Patent Application Publication
(10) Pub. No.: US 2011/0162627 A1
(43) Pub. Date: Jul. 7, 2011

(54) MIXED ELECTRONIC IGNITION SYSTEM INTEGRATED WITH A DISTRIBUTOR STRUCTURE AND AN ENGINE CONTROL UNIT

(76) Inventor: LAWRENCE HUNG, RICHMOND (CA)

(21) Appl. No.: 12/683,699

(22) Filed: Jan. 7, 2010

(51) Int. Cl. F02P 3/02

(52) U.S. Cl. 123/647

(57) ABSTRACT

A mixed electronic ignition system integrated with a distributor structure and having an engine control unit includes a pickup coil kit, a sensor unit, an ignition module unit, a coil pack unit and a plurality of spark plugs. The sensor control unit includes a waveform converter, a first cylinder position sensor and a microprocessor. The microprocessor is electrically coupled to the waveform converter and the first cylinder position sensor for outputting a continuous timing ignition datum. The continuous timing ignition datum is provided for controlling an ignition or explosion of each cylinder effectively, and the microprocessor is installed for converting a conventional mechanical distributor ignition system into a microcomputer controlled electronic ignition system, and thus the mixed electronic ignition system is concurrently useful and economic effective.

### BACKGROUND OF THE INVENTION

1. Field of the Invention

The present invention relates to an automobile ignition system, and more particularly to a mixed electronic ignition system integrated with a distributor structure and an engine control unit.

2. Description of the Related Art

A gas engine is operated by injecting mixed petroleum and air into cylinders of the engine, and igniting the petroleum injected in the cylinders through spark plugs for a combustion and/or explosion to produce motive power. A mechanical distributor ignition system is generally used as a traditional way of igniting the spark plugs, and most present automobile models adopt a microcomputer controlled electronic ignition system.

With reference to FIG. 1 for a conventional mechanical distributor ignition system 1, a switch 11 connected with an input end of a coil pack unit 12 is used for supplying a power source 10, and the switch 11 is provided for controlling an output voltage at an anode of the coil pack unit 12. A cathode of the coil pack unit 12 is connected to an ignition module 14 installed in a distributor 13, and the ignition module 14 is used for disconnecting a primary coil voltage to induce a secondary coil in order to output a high voltage, and a rotor installed in the distributor 13 outputs the high voltage to ignite each spark plug 15 through a connected high voltage conductive wire, wherein the ignition sequence is controlled according to the rotation of the engine, so that the distributor 13 and a cam shaft of the engine can be engaged with each other to rotate the axle center of the distributor 13 at the same speed synchronously to achieve the function of a sequential power distribution.

Compared with the aforementioned conventional ignition system, most of the present automobile types adopt the microcomputer controlled electronic ignition system, wherein an engine control unit (ECU) is integrated directly with the computation and the control of different data for achieving a precise ignition of each spark plug without adopting the mechanical distributor structure anymore.

Unlike the conventional mechanical distributor ignition system, the microcomputer controlled electronic ignition system performs an early ignition which is controlled by the ECU, but the distribution and ignition still adopt the mechanical structure to rotate the distributor, so as to ignite each spark plug sequentially. Therefore, related mechanical components may be damaged easily after a long-time use. For example, the distributor cap and the rotor may be deteriorated or leaked easily, and the ignition module may be damaged frequently due to its overload. Furthermore, an ignition system of a mechanical distributor generally incurs a high power loss, and thus the ignition efficiency is lower than that of the microcomputer controlled ignition system.

Although the microcomputer controlled electronic ignition system can overcome the shortcomings of the conventional indirect ignition through the distributor, its electric power distribution is totally different from that of the conventional distributor, and it is difficult to install the microcomputer controlled electronic ignition system directly to the automobile types that adopt the conventional distributor structure.

In view of the description above, the inventor of the present invention designed a mixed electronic ignition system integrated with a distributor structure, wherein the electronic ignition system converts the conventional mechanical distributor ignition system into a microcomputer controlled electronic ignition system. Without changing the existing equipments of an automobile, an engine control unit of existing automobile models is used together with a special operating principle of a microprocessor in accordance with the present invention to achieve the advantages of modifying the existing automobile model easily and providing the microcomputer controlled electronic ignition effect.

### SUMMARY OF THE INVENTION

Therefore, it is a primary objective of the present invention to overcome the shortcomings of the prior art by providing a mixed electronic ignition system integrated with a distributor structure and having an engine control unit, so that existing automobile models having a mechanical ignition system can be remodeled into a microcomputer controlled electronic ignition system easily to overcome the problems of having easily worn-out mechanical parts and a difficult control of precision.

To achieve the foregoing objective, the present invention provides a mixed electronic ignition system integrated with a distributor structure and an engine control unit (ECU), comprising: a pickup coil kit, a sensor control unit, a coil pack unit, an ignition module unit and a plurality of spark plugs. The pickup coil kit includes a pickup coil and a timing disk for generating a sine-wave datum; and the sensor control unit is electrically coupled to the engine control unit and includes: a waveform converter, connected to the pickup coil kit, for converting the sine-wave datum into a square-wave datum and outputting the square-wave datum to the engine control unit, wherein the engine control unit processes and generates an early ignition datum; a first cylinder position sensor, for outputting a first cylinder position signal; and a microprocessor, electrically coupled to the waveform converter and the first cylinder position sensor, for receiving the first cylinder position signal and the early ignition datum to output a continuous timing ignition datum; and the coil pack unit, electrically coupled to the ignition module unit, and having a plurality of high-voltage coils, wherein the ignition module unit is electrically coupled to the microprocessor for driving and controlling the high-voltage coil, and the spark plugs are electrically coupled to the coil pack unit.

The present invention has the effect of converting a conventional mechanical distributor ignition system into a microcomputer controlled electronic ignition system without changing the present existing equipments and structures of an automobile, and the invention is capable of modifying the system easily to achieve the electronic ignition effect, and thus the invention is useful and economic-effective.

### BRIEF DESCRIPTION OF THE DRAWINGS

FIG. 1 is a block diagram of a conventional mechanical distributor ignition system; and

FIG. 2 is a block diagram of a mixed electronic ignition system integrated with a distributor structure in accordance with the present invention.

FIG. 3, FIG. 4A, and FIG. 4B are the same system as FIG. 2 presented only different in design and hardware used.

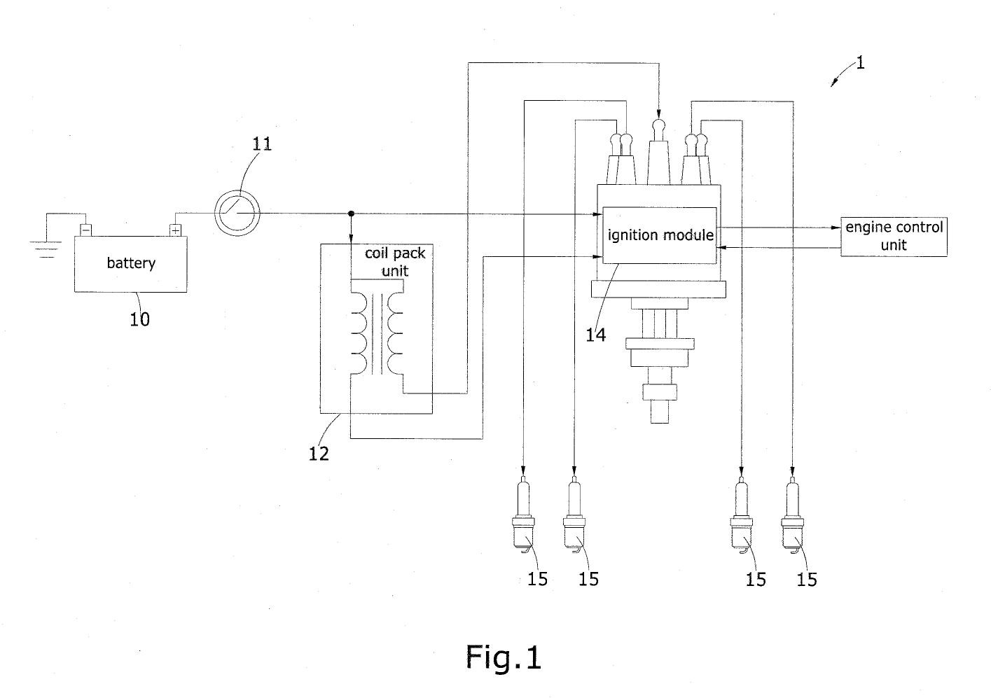

### DETAILED DESCRIPTION OF THE PREFERRED EMBODIMENTS

To make it easier for our examiner to understand the technical contents of the invention, we use preferred embodiments together with the attached drawings for the detailed description of the invention.

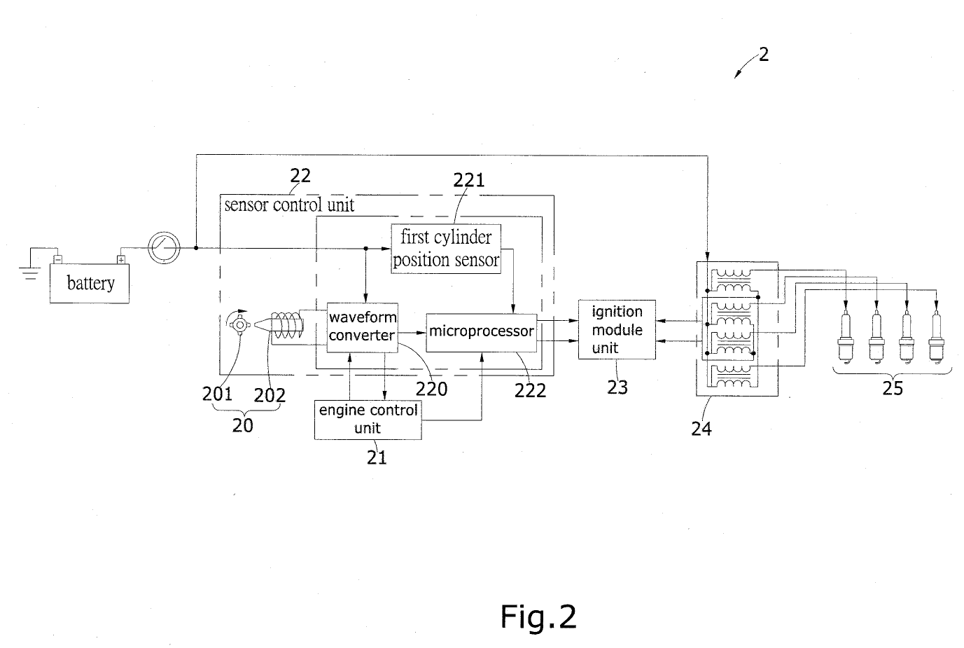

With reference to FIG. 2 for a block diagram of a mixed electronic ignition system integrated with a distributor structure and an engine control unit (ECU) in accordance with a preferred embodiment of the present invention, the mixed electronic ignition system 2 comprises: a pickup coil kit 20, a sensor control unit 22, an ignition module unit 23 which will house one or more ignition modules inside the unit, a coil pack unit 24, and a plurality of spark plugs 25. The sensor control unit 22 is electrically coupled to the engine control unit 21 and includes a waveform converter 220, a first cylinder position sensor 221, and a microprocessor 222. All operations of the engine are performed with respect to a crank shaft, which drives the cam shaft, and finally ignition timing is determined by the cam shaft, and thus each component requires a correct timing signal. The present invention achieves the aforementioned effect by using the pickup coil kit 20 which is comprised of a pickup coil and a timing core. When the cam shaft rotates, the timing disk will keep the cam shaft to be rotated at the same speed, and when each tooth of the timing disk passes through the pickup coil, a magnetic field will be detected. According to the Lenz law and the principles of magnetic induction, an induction coil cuts the lines of magnetic force to induce a voltage signal. The induced voltage signal is a sine-wave datum, such that the sine-wave datum can be processed as a digital signal, and the pickup coil kit 20 is coupled with a waveform converter 220 installed in the sensor control unit 22 for converting the sine-wave datum into a square-wave datum, and then the square-wave datum is outputted to the engine control unit 21 for data processing to produce an early ignition datum which contains the content of a continuous ignition sequence of the cylinders.

After an early ignition datum is obtained through the engine control unit 21, it is necessary to set a starting point of every ignition cycle (which is a first cylinder signal). After the first cylinder signal is set, a sequence of ignitions of the cylinders can be carried out. The present invention achieves a detection effect by using a first cylinder position sensor 221, which can be a Hall sensor as used in this embodiment of the invention. If the crank shaft rotates two rounds, the cam shaft will rotate one round. Now, the Hall sensor can provide a pulse voltage to identify the plug position of a first cylinder, which indicates the first cylinder signal. After the early ignition datum is outputted from the engine control unit 21 to the microprocessor 222, the first cylinder signal is inputted into the microprocessor 222 to identify the starting point of the early ignition datum. After the microprocessor processes the aforementioned two types of data, an appropriate ignition process for igniting the coil can be set. In addition, the first cylinder signal is a voltage signal that can be detected by the Hall sensor to generate a square waveform, and thus the signal can be used directly for a digital control without requiring a conversion of the signal.

The microprocessor 222 is electrically coupled to the waveform converter 220 and the first cylinder position sensor 221, so that the microprocessor 222 can integrate and process the first cylinder signal and the early ignition datum to output a continuous timing ignition datum. The continuous timing ignition datum is provided for outputting a plurality of alternately started square waves simultaneously. Unlike the conventional ECU that outputs a single continuous square wave for the ignition control, the present invention uses the continuous timing ignition datum to output two sets of alternately started square waves simultaneously for a 4-cylinder engine in a preferred embodiment. The first set of square waves control an ignition or an explosion of the first and fourth cylinders, and the second set of square waves control the ignition or explosion of the second and third cylinders. After the first set of square waves is outputted to the ignition module unit 23 to disconnect the power source, a secondary coil is induced to generate a high voltage to the spark plug 25 of the first cylinder for the ignition or explosion. Now, the fourth cylinder is situated at a gas discharge position, and thus will not be affected. After the second set of square waves is outputted to the ignition module unit 23 to disconnect the power source, a secondary coil is induced to generate a high voltage to the spark plug 25 of the third cylinder for the ignition or explosion. Now, the second cylinder is situated at a gas discharge position, and thus will not be affected. And then, the ignition and explosion are conducted at the fourth cylinder; the gas in the first cylinder is discharged; the ignition and explosion are conducted at the second cylinder; and the gas in the third cylinder is discharged, so as to complete a cycle of the operation of the cylinders of an engine cylinder. Similarly, three and four sets of alternately started square waves are outputted for a 6-cylinder and an 8-cylinder engine respectively.

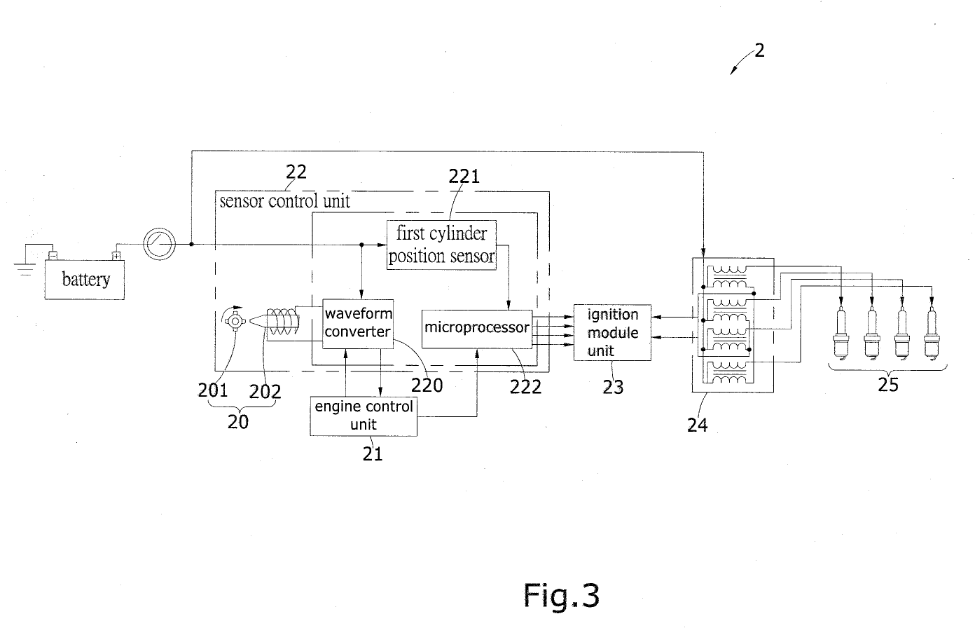

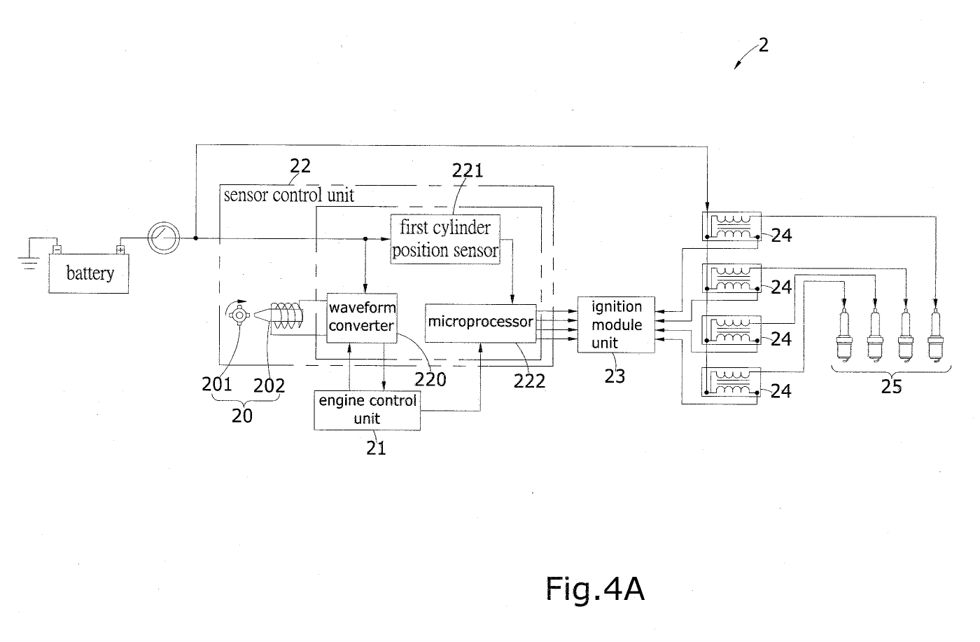

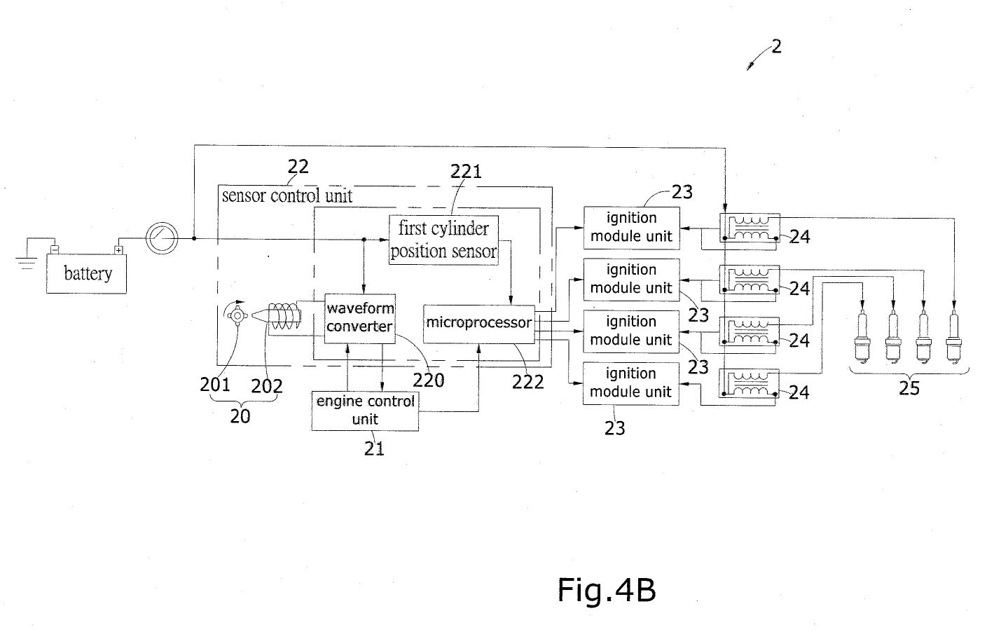

With reference to FIG. 3 the theory is the same as FIG. 2, the only difference is from the invention uses the continuous timing ignition datum to output two sets of alternately started square waves from the microprocessor 222 simultaneously for a 4-cylinder engine in a preferred embodiment. The FIG. 3 shows the microprocessor 222 uses the continuous timing ignition datum to output four alternately started square waves. The first square wave and fourth square wave controls an ignition or an explosion of the first and fourth cylinders, and the second square wave and third square wave controls the ignition or explosion of the second and third cylinders. After the first square wave and fourth square wave is outputted to the ignition module unit 23 to disconnect the power source, a secondary coil is induced to generate a high voltage to the spark plug 25 of the first cylinder for the ignition or explosion. Now, the fourth cylinder is situated at a gas discharge position, and thus will not be affected. After the second square wave and third square wave is outputted to the ignition module unit 23 to disconnect the power source, a secondary coil is induced to generate a high voltage to the spark plug 25 of the third cylinder for the ignition or explosion. Now, the second cylinder is situated at a gas discharge position, and thus will not be affected. And then, the ignition and explosion are conducted at the fourth cylinder; the gas in the first cylinder is discharged; the ignition and explosion are conducted at the second cylinder; and the gas in the third cylinder is discharged, so as to complete a cycle of the operation of the cylinders of an engine cylinder. Similarly, six and eight alternately started square waves are outputted for a 6-cylinder and an 8-cylinder engine respectively.

With reference to FIG. 4A for a block diagram of a mixed electronic ignition system integrated with a distributor structure and an engine control unit 21 (ECU) in accordance with a preferred embodiment of the present invention, the mixed electronic ignition system 2 comprises: a pickup coil kit 20, a sensor control unit 22, an ignition module unit 23 (which house multiple individual ignition modules inside the unit), a individual coil unit or known as the pencil coil 24, and a plurality of spark plugs 25. The sensor control unit 22 is electrically coupled to the engine control unit 21 and includes a waveform converter 220, a first cylinder position sensor 221, and a microprocessor 222. All operations of the engine are performed with respect to a crank shaft, and a cam shaft is driven, and finally ignition timing is determined by the cam shaft, and thus each component requires a correct timing signal. The present invention achieves the aforementioned effect by using the pickup coil kit 20 which is comprised of a pickup coil and a timing core. When the cam shaft rotates, the timing disk will keep the cam shaft to be rotated at the same speed, and when each tooth of the timing disk 201 passes through the pickup coil 202, a magnetic field will be detected. According to the Lenz law and the principles of magnetic induction, an induction coil cuts the lines of magnetic force to induce a voltage signal. The induced voltage signal is a sine-wave datum, such that the sine-wave datum can be processed as a digital signal, and the pickup coil kit 20 is coupled with a waveform converter 220 installed in the sensor control unit 22 for converting the sine-wave datum into a square-wave datum, and then the square-wave datum is outputted to the engine control unit 21 for data processing to produce an early ignition datum which contains the content of a continuous ignition sequence of the cylinders.

After an early ignition datum is obtained through the engine control unit 21, it is necessary to set a starting point of every ignition cycle (which is a first cylinder signal). After the first cylinder signal is set, a sequence of ignitions of the cylinders can be carried out. The present invention achieves a detection effect by using a first cylinder position sensor 221, which can be a Hall sensor as used in this embodiment of the invention. If the crank shaft rotates two rounds, the cam shaft will rotate one round. Now, the Hall sensor can provide a pulse voltage to identify the plug position of a first cylinder, which indicates the first cylinder signal. After the early ignition datum is outputted from the engine control unit 21 to the microprocessor 222, the first cylinder signal is inputted into the microprocessor 222 to identify the starting point of the early ignition datum. After the microprocessor 222 processes the aforementioned two types of data, an appropriate ignition process for igniting the coil can be set. In addition, the first cylinder signal is a voltage signal that can be detected by the Hall sensor to generate a square waveform, and thus the signal can be used directly for a digital control without requiring a conversion of the signal.

The microprocessor 222 is electrically coupled to the waveform converter 220 and the first cylinder position sensor 221, so that the microprocessor 222 can integrate and process the first cylinder signal and the early ignition datum to output a continuous timing ignition datum. The continuous timing ignition datum is provided for outputting a plurality of alternately started square waves simultaneously. Unlike the conventional ECU that outputs a single continuous square wave for the ignition control, this presented block diagram invention uses the continuous timing ignition datum to output four alternately started square waves simultaneously for a 4-cylinder engine in a preferred embodiment. The first square waves control an ignition or an explosion of the first cylinder, the second square waves control the ignition or explosion of the second cylinder, the third square waves control the ignition or explosion of the third cylinder and the fourth square waves control the ignition or explosion of the fourth cylinder. After the first square waves are outputted to the ignition module unit 23 to disconnect the power source, a secondary coil is induced to generate a high voltage to the spark plug 25 of the first cylinder for the ignition or explosion. Now, the third square waves are outputted to the ignition module unit 23 to disconnect the power source, a secondary coil is induced to generate a high voltage to the spark plug 25 of the third cylinder for the ignition or explosion. Next the fourth square waves are outputted to the ignition module unit 23 to disconnect the power source, a secondary coil is induced to generate a high voltage to the spark plug 25 of the fourth cylinder for the ignition or explosion. Finally, followed by the second square waves are outputted to the ignition module unit 23 to disconnect the power source, a secondary coil is induced to generate a high voltage to the spark plug 25 of the second cylinder for the ignition or explosion, so as to complete a cycle of the operation of the cylinders of an engine cylinder. Similarly, six and eight alternately started square waves are outputted for a 6-cylinder and an 8-cylinder engine respectively.

With reference to FIG. 4B the theory and the function are the same, the only difference is the drawing of the FIG. 4A the ignition module unit 23 are now drawn in individual ignition module. As in hardware both FIG. 4A and FIG. 4B the coils have been separated individually, instead of one coil pack (which house multiple coils). The ignition module can be designed to be housed within the individual coil unit (commonly known as a pencil coil) or can be installed within the coil pack.

The individual ignition module includes at least one insulated gate bipolar transistor (IGBT), such that sparks will not be produced at the coil since the IGBT has no concern of contact points, and a more stable sparking of the secondary coil can be achieved to assure a stable ignition timing. After the ignition module unit 23 disconnects a low-voltage power source according to the continuous timing ignition datum, a high voltage is induced at a secondary side of the coil pack unit or individual coil unit known as pencil coil 24 to supply a high-voltage power source to the spark plugs 25 to ignite the gas in the cylinder for an explosion.

The mixed electronic ignition system of the present invention converts a conventional mechanical distributor ignition system into a microcomputer controlled electronic ignition system without changing the present existing equipments of the automobile, but still uses the engine control unit of existing models to operate together with the microprocessor of the present invention to provide an easy way of modifying the old models to achieve a microcomputer controlled electronic ignition, and thus the present invention is useful and economic effective.

The present invention can be applied to specific automobiles with the models, types, manufacturing dates and exhaustion capacity as listed in the following table:

Applications below are for the OEM#1103829A Ignition Distributor

| | | | |
|---|---|---|---|
| Buick | | 85-86 | 2500 cc 151 ci |
| Buick | Century | 85-86 | 2500 cc 151 ci |
| Buick | Skylark | 85-86 | 2500 cc 151 ci |
| Buick | Somerset | 85-86 | 2500 cc 151 ci |
| Chevrolet | | 85-86 | 2500 cc 151 ci |
| Chevrolet | | 85-86 | 2500 cc 151 ci |
| Chevrolet | Astro Mini Van | 85-87 | 2500 cc 151 ci |
| Chevrolet | Astro Mini Van | 88 | 2500 cc 151 ci |
| Chevrolet | Astro Mini Van | 89-90 | 2500 cc 151 ci |
| Chevrolet | Camaro | 85-86 | 2500 cc 151 ci |
| Chevrolet | Celebrity | 85-86 | 2500 cc 151 ci |
| Chevrolet | Citation | 85-86 | 2500 cc 151 ci |
| Chevrolet | Post Office Vehicle | 92-93 | 2500 cc 151 ci |
| Chevrolet | Post Office Vehicle | 91 | 2500 cc 151 ci |
| Chevrolet | S Series P/U | 91 | 2500 cc 151 ci |
| Chevrolet | S Series P/U | 92-93 | 2500 cc 151 ci |
| Chevrolet | Safari Mini Van | 85-87 | 2500 cc 151 ci |
| Chevrolet | Safari Mini Van | 88 | 2500 cc 151 ci |
| Chevrolet | Safari Mini Van | 89-90 | 2500 cc 151 ci |
| Chevrolet | Sonoma | 91 | 2500 cc 151 ci |
| Chevrolet | Sonoma | 92-93 | 2500 cc 151 ci |
| GMC | Truck | 85-87 | 2500 cc 151 ci |
| GMC | Truck | 88 | 2500 cc 151 ci |
| GMC | Truck | 91 | 2500 cc 151 ci |
| GMC | Truck | 92-93 | 2500 cc 151 ci |
| Oldsmobile | Calais | 85-86 | 2500 cc 151 ci |
| Oldsmobile | Cutlass Ciera | 85-86 | 2500 cc 151 ci |
| Pontiac | 6000 | 85-86 | 2500 cc 151 ci |
| Pontiac | Fiero | 85-86 | 2500 cc 151 ci |
| Pontiac | Firebird | 85-86 | 2500 cc 151 ci |
| Pontiac | Grand Am | 85-86 | 2500 cc 151 ci |
| Pontiac | Phoenix | 85-86 | 2500 cc 151 ci |
| Pontiac | | 85-86 | 2500 cc 151 ci |

Applications below are for the OEM#1103625E Ignition Distributor

| | | | |
|---|---|---|---|
| Buick | Century | 82-83 | 2500 cc 151 ci |
| Buick | Skylark | 82-83 | 2500 cc 151 ci |
| Buick | | 82-83 | 2500 cc 151 ci |
| Chevrolet | | 82-83 | 2500 cc 151 ci |
| Chevrolet | Camaro | 82-83 | 2500 cc 151 ci |
| Chevrolet | Celebrity | 82-83 | 2500 cc 151 ci |
| Chevrolet | Citation | 82-83 | 2500 cc 151 ci |
| Chevrolet | | 82-83 | 2500 cc 151 ci |
| Chevrolet | Truck | 85-88 | 2500 cc 151 ci |
| Chevrolet | Truck | 89-90 | 2500 cc 151 ci |
| Chevrolet | Truck | 91 | 2500 cc 151 ci |
| Chevrolet | Jimmy | 85-88 | 2500 cc 151 ci |
| Chevrolet | Post Office Vehicle | 85-88 | 2500 cc 151 ci |
| Chevrolet | Post Office Vehicle | 89-90 | 2500 cc 151 ci |
| Chevrolet | Post Office Vehicle | 91 | 2500 cc 151 ci |
| Chevrolet | S Series Blazer | 85-88 | 2500 cc 151 ci |
| Chevrolet | S Series P/U | 85-88 | 2500 cc 151 ci |
| Chevrolet | S Series P/U | 89-90 | 2500 cc 151 ci |
| Chevrolet | S Series P/U | 91 | 2500 cc 151 ci |
| Chevrolet | Sonoma | 89-90 | 2500 cc 151 ci |
| Chevrolet | Sonoma | 91 | 2500 cc 151 ci |
| GMC | Truck | 85-88 | 2500 cc 151 ci |
| GMC | Truck | 89-90 | 2500 cc 151 ci |
| GMC | Truck | 91 | 2500 cc 151 ci |
| Oldsmobile | Ciera | 82-83 | 2500 cc 151 ci |
| Oldsmobile | Omega | 82-83 | 2500 cc 151 ci |
| Pontiac | 6000 | 82-83 | 2500 cc 151 ci |
| Pontiac | Firebird | 82-83 | 2500 cc 151 ci |
| Pontiac | Phoenix | 82-83 | 2500 cc 151 ci |
| Pontiac | | 82-83 | 2500 cc 151 ci |

The table above is for the illustration purpose only, but the invention is not limited to the application of the mentioned automobiles only. The present invention can be applied to equivalent automobiles other than those listed and used for modifying the ignition system to the microcomputer controlled electronic ignition system.

While the invention has been described by means of specific embodiments, numerous modifications and variations could be made thereto by those skilled in the art without departing from the scope and spirit of the invention set forth in the claims.

What is claimed is:

1. A mixed electronic ignition system integrated with a distributor structure and an engine control unit, comprising:
a pickup coil kit, having a pickup coil and a timing disk for generating a sine-wave datum;
a sensor control unit, electrically coupled to the engine control unit, the sensor control unit, and including:
a waveform converter, connected to the pickup coil kit, for converting the sine-wave datum into a square-wave datum, and outputting the square-wave datum to the engine control unit, and the engine control unit processing the square-wave datum to generate an early ignition datum;
a first cylinder position sensor, for outputting a first cylinder position signal; and
a microprocessor, electrically coupled to the waveform converter and the first cylinder position sensor, for receiving the first cylinder position signal and the early ignition datum to output a continuous timing ignition datum;
a coil pack unit, electrically coupled to the ignition module, and having a plurality of high-voltage coils;
an ignition module unit which will house one or more ignition modules inside the unit, electrically coupled to the microprocessor, for driving and controlling the high-voltage coil; and
a plurality of spark plugs, electrically coupled to the coil pack unit.

2. The electronic ignition system of claim 1, wherein the continuous timing ignition datum is provided for outputting a plurality of alternately started square waves simultaneously.

3. The electronic ignition system of claim 1, wherein the first cylinder position sensor is a Hall sensor.

4. The electronic ignition system of claim 1, wherein the ignition module unit includes at least one insulated gate bipolar transistor (IGBT).
